(19) United States
(12) Patent Application Publication
(10) Pub. No.: US 2009/0055322 A1
(43) Pub. Date: Feb. 26, 2009

(54) REMOVABLE MODULE IN PERSONAL HANDHELD DEVICES FOR PERSONAL INFORMATION EXCHANGE

(75) Inventors: Sergey I. Bykov, Redmond, WA (US); Charles J. Williams, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/844,078

(22) Filed: Aug. 23, 2007

(51) Int. Cl. G06F 17/00; G06Q 40/00; H04L 9/00

(52) U.S. Cl. 705/64; 705/1; 705/16; 705/42

(57) ABSTRACT

A personal information exchange module in a standardized form is used as a plug-in to a personal handheld device for information exchange such as financial transactions, facility access, medical information exchange, and the like while protecting sensitive code and data associated with the module by separating those from the operating environment of the personal handheld device. Functional capabilities of the module may also be adjusted based on available power from the personal handheld device.

### BACKGROUND

With the proliferation of personal handheld devices such as smart mobile phones, there is increased interest in mobile wallet solutions that enable consumers to pay for their purchases with their mobile phones and perform similar actions. A mobile wallet is a program that runs on the phone, stores payment instrument information such as credit card data, and enables a user to make purchases. At the time of a payment transaction, the program sends the payment instrument information to the receiver that can be a Point of Sale (POS) terminal, payment terminal, and Automated Teller Machine (ATM), etc.

One of the challenges with mobile wallets is storing payment instrument data securely so that it cannot be easily extracted from a stolen phone. Another challenge is protection of the software code that handles sensitive information. If the code runs on the same processor and in the same environment as other software components of the phone, it may be difficult or impossible to ensure isolation of the sensitive code and data as it can be compromised by other software running on the phone. Compatibility may also present difficulties for such a combination system since different phone models typically have different and often incompatible software execution environments that may hinder portability of mobile wallet between different phone models.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to enabling use of personal handheld devices for personal information exchange requiring services such as payment applications, access applications, and the like. According to embodiments, a personal information exchange application may be executed in a hardware software combination module that fits into a standardized connection in the personal handheld device such as a Subscriber Identity Module (SIM) card. According to other embodiments, the hardware software combination may be enabled with additional capabilities such as passive communication independent of the personal handheld device's communication system, control of personal information exchange application's capabilities based on available power, and so on.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1A-1C illustrate example usage scenarios of a personal handheld device with personal information exchange application according to embodiments;

FIG. 2 illustrates the front view of an example personal handheld device which may include a module for personal information exchange;

FIG. 3 illustrates the rear view of an example personal handheld device which may include a module for personal information exchange;

FIG. 4 is a conceptual diagram illustrating relationships of a payment application incorporated into a smart phone device and the main phone application(s);

FIG. 5 is an example networked environment, where embodiments may be implemented;

FIG. 6 is a block diagram of an example computing operating environment, where embodiments may be implemented; and

FIG. 7 illustrates a logic flow diagram for a process of facilitating a personal information exchange application within a personal handheld device environment.

### DETAILED DESCRIPTION

As briefly described above, a hardware software combination module may be employed to incorporate a personal information exchange application into a personal handheld device. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

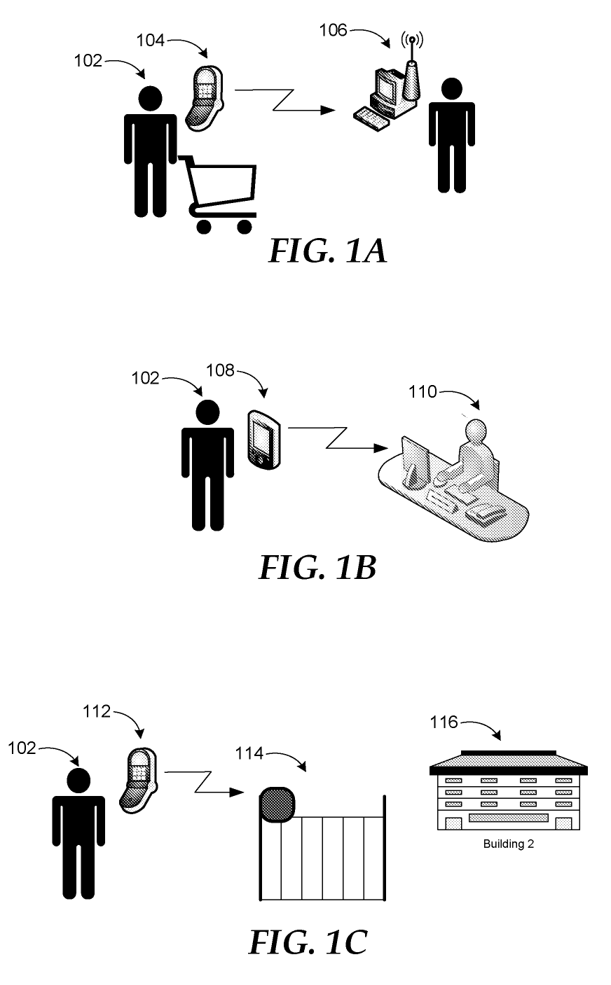

Referring to FIG. 1A-1C, example usage scenarios of a personal handheld device with personal information exchange application according to embodiments are illustrated. A personal handheld device as used herein is any portable computing device that is capable of performing tasks such as communication, scheduling, audio/video/image processing and presentation, and the like. A smart phone, a portable music player, a portable audio/video player, a remote control device, and a personal digital assistant (PDA) are examples of personal handheld devices. Embodiments are not limited to these example devices, however. Other types of portable devices may also be used to incorporate a personal information exchange module. For example, even a medical monitoring device may be used with a personal information exchange module as described herein.

Personal information exchange is part of almost every aspect of today's life. People make payments providing personal information such as credit card data, provide identity information at medical offices and similar places, and even use identity information for accessing facilities such as at electronically controlled gates.

FIG. 1A shows a consumer (102) making payment using a smart phone (104) at a Point Of Sale (POS) terminal 106. FIG. 1B shows a patient 102 providing personal information to a receptionist 110 at a doctor's office using his PDA (108). FIG. 1C shows a person (102) opening a gate 114 to access a facility 116 using his smart phone 112.

As mentioned previously, incorporating a personal information exchange application directly into a personal handheld device has its challenges such as protection of sensitive software code, compatibility between different handheld device operating systems and the application program(s), and so on. Another challenge in the specific example of incorporating payment instruments into smart phones is that provisioning of mobile wallets as it takes physical or over the air (OTA) access to the phone to initialize or update the phone with the payment instrument information and other related data.

Furthermore, some mobile wallet solutions may be blocked by the conflict of interests, ownership, and business models between mobile service providers and financial institutions. Both parties have their own relations with the customer: for the service providers, the customer is a mobile phone subscriber, for the financial institution, the same customer is an accountholder. The service providers may refuse to give access to the phone software by any external application considering it their asset. The financial institutions may be reluctant to have the service providers involved in their transactions and fees.

According to some embodiments, a hardware software combination module may be attached to the personal handheld device through a standardized connection and be capable of executing its own application without having to share sensitive code or data with the handheld device's own software.

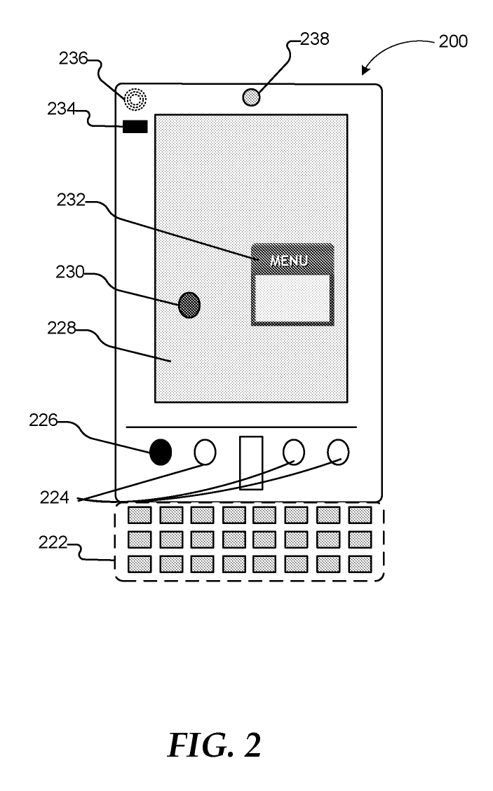

FIG. 2 illustrates the front view of an example personal handheld device which may include a module for personal information exchange. While personal handheld devices according to embodiments may take many forms, a smart phone/PDA device is illustrated in the figure as an example.

Personal handheld device 200 is shown with many features. However, embodiments may be implemented with fewer or additional components. Example personal handheld device 200 includes typical components of a mobile communication device such as a hard keypad 222, specialized buttons (“function keys”) 224 and 226, display 228, and one or more indicators (e.g. LED) 234. Personal handheld device 200 may also include a camera 238 for video communications and microphone 236 for voice communications. Display 228 may be an interactive display (e.g. touch sensitive) and provide soft keys (e.g. 230) as well.

In addition to providing a Graphical User Interface (GUI) for the main application(s) such as communication application, scheduling application, and the like, of the personal handheld device 200, the display 228 may also present a GUI for the personal information exchange application to the user. For example, an application user interface may display options to a user to make payment from an account, the amount, account balance, and so on. For an identity verification application, the GUI may again provide options for the user to select as to which personal information should be provided (e.g. social security number, address, etc.). Some or all of the information exchange may also be automated and the user simply provided a confirmation that the transaction has taken place. Some of the specialized buttons and/or soft keys may be used by the personal information exchange application GUI.

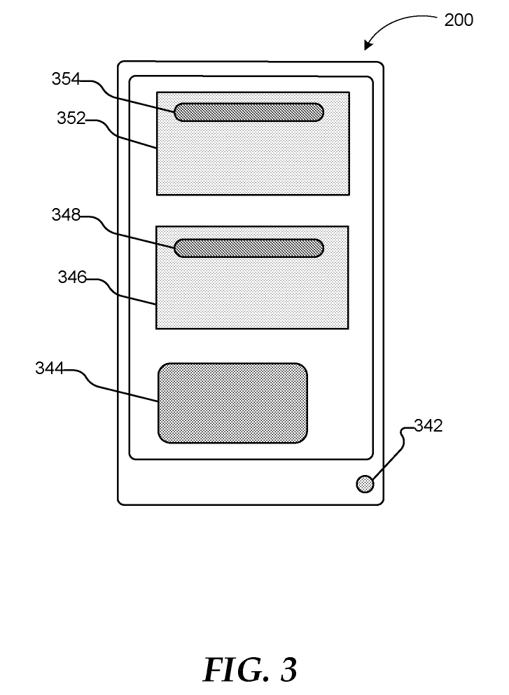

FIG. 3 illustrates the rear view of an example personal handheld device which may include a module for personal information exchange. A personal handheld device may typically include a battery 344, power connection 342, and one or more standardized modules (e.g. modules 346 and 352 and their connectors 348 and 354).

A personal information exchange module according to embodiments may be implemented as a standardized module that can be easily plugged into any personal handheld device. For example, the personal information exchange module may be in SIM form, which is accepted by a majority of cellular phones today. Many personal handheld devices, such as PDAs, also include memory module slots where memory or similar modules may be plugged in.

In the example of a payment module, a module provided by a financial institution may execute sensitive code and store sensitive financial data with its appropriate security measures. A user may obtain this module from their financial institution and plug into a SIM card slot (if the module is in SIM form) of their cellular phone and use the phone for financial transactions transparent to the main functionality of the phone. Since the sensitive code and data is not transferred to the control of the phone's operating system, the module's integrity is protected and compatibility issues may be minimized by using standard APIs.

The personal information exchange module may be configured to operate in various modes. For example, the module may be configured to use the host device (personal handheld device) only as a power source by connecting to the battery of the host device without interacting with the device operating system. The interaction between the host device and the module may be arranged in varying degrees. According to another example, the keypad of the personal handheld device may be used for basic interaction with the module such as PIN entry without further interaction with the operating system. According to a further example, the module may interact directly with the screen and the keyboard bypassing the local operating system all together.

On the other end of the spectrum, the module may be designed for fully compatible operation with the host device's operating system enabling the personal handheld device to display a GUI for the module's software application and the user's interaction with the module's application beyond simple PIN entry. Such interactions may include account selection, balance check, transaction history review, personal information selection, and the like.

As described above, the personal information exchange application may be configured to be executed partially in the module and partially in the personal handheld device such that sensitive code and data are protected physically within the module, while the application takes advantage of power management and user interface capabilities of the host device's operating system.

A personal information exchange module according to embodiments may be an active device that requires external power from the host device to operate or a passive device that is powered by electromagnetic waves transmitted from a terminal device (e.g. a passive card). The power use of the personal information exchange module may be configured based on the available power from the host device. This can be managed in a variety of ways.

The power management can vary from a simple turning off the module when sufficient power is no longer available to adjusting capabilities of the module based on available power. For example, a payment module with an interactive GUI (mobile banking functions) may have its mobile banking capabilities (e.g. checking transaction history, balance, etc.) limited if available power is insufficient. A module that is capable of operating as an active module and a passive module may be switched to a passive operation mode, when the host device has insufficient power allowing the user to continue making payments even when their cellular phone has run out of battery, for example. Similarly, a facility access module may still be used even when the personal handheld device is turned off, if the module is set to passive operation mode (e.g. Near Field Communications).

As discussed above, the personal information exchange module may be implemented in a standardized form such as a SIM card. These standardized forms may be employed across different types of personal handheld devices. For example, SIM card slots may be designed into portable audio/video players, PDAs, or even remote control devices allowing a user to move their module from one portable device to another.

Moreover, a personal handheld device such as those described in conjunction with FIG. 2 and FIG. 3 may be equipped with additional authentication mechanisms such as fingerprint recognition, voice recognition, and the like. A module according to embodiments may be configured to authenticate the user through one of these mechanisms before executing the transaction(s).

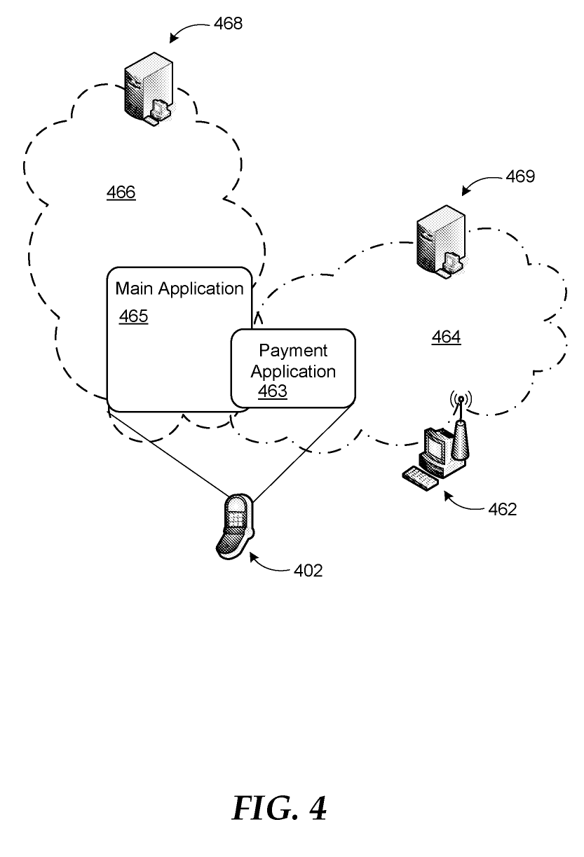

FIG. 4 is a conceptual diagram illustrating relationships of an example payment application incorporated into a smart phone device and the main phone application(s). While a variety of personal handheld devices may be used as a host device for a module according to embodiments and the host devices may or may not include communication capability, an expected area of use for such a module is a mobile wallet application as part of a smart phone device. Moreover, smart phones utilizing cellular technology are common today, but with the development of newer network communication technologies and increased bandwidth and processing power, handheld devices using other communication technologies and providing additional services are not in the too distant future. A mobile wallet module according to embodiments would be just as applicable with the personal handheld devices of the future as those available today.

In the figure, smart phone 402 is illustrated as having a main application 465, which manages communication capabilities of the phone as part of a network 466 that may be managed by a central server or group of servers (468). The mobile wallet module of the phone enables payment application 463 to be executed in conjunction with the main application 465 of the phone.

When a transaction is performed, payment application 463 may communicate with a terminal device 462, which is part of a network 464 managed by one or more servers (469) of the financial institution issuing (or authorizing) the module.

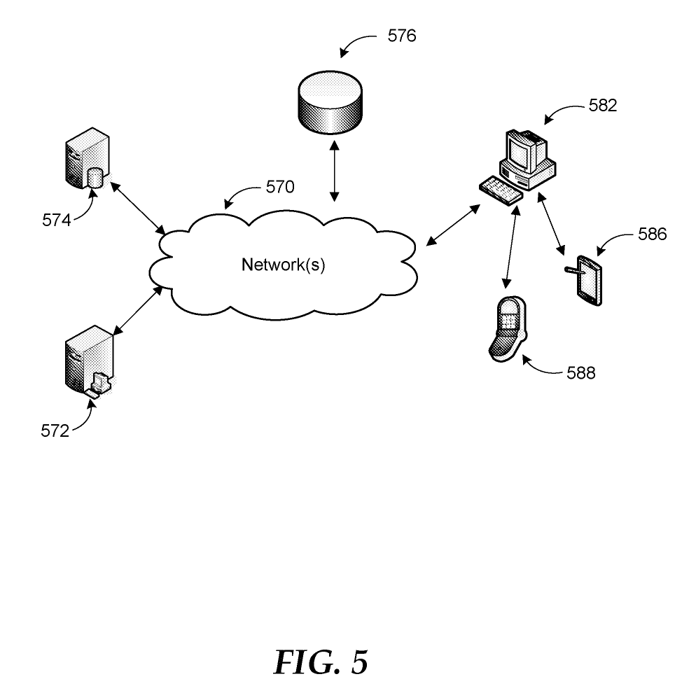

FIG. 5 is an example networked environment, where embodiments may be implemented. A personal information exchange module is configured to communicate with another device, such as a POS terminal, for exchange of personal information. The other device is commonly part of a larger network of devices managed by one or more servers. Such a system may be implemented in a distributed manner over a number of physical and virtual clients and servers. It may also be implemented in un-clustered systems or clustered systems employing a number of nodes communicating over one or more networks (e.g. network(s) 570).

The system may comprise any topology of servers, clients, Internet service providers, and communication media. Also, the system may have a static or dynamic topology. The term “client” may refer to a client application or a client device. While a networked system implementing communication with a personal information exchange module may involve many more components, relevant ones are discussed in conjunction with this figure.

A module according to embodiments is typically plugged into a personal handheld device such as cellular phone 588 or PDA 586. The module communicates, again commonly through near field communications, but not limited to that communication form, with other devices such as terminal 582. Terminal 582 is connected to a larger network managed by server 572 for performing the transactions associated with the module.

Data stores associated with personal information exchange may be embodied in a single data store such as data store 576 or distributed over a number of data stores associated with individual client devices, servers, and the like. Dedicated database servers (e.g. database server 574) may be used to coordinate data retrieval and storage in one or more of such data stores. The data store(s) may store information associated with the modules and/or users such as identifying information, security information, access information, and the like.

Network(s) 570 may include a secure network such as an enterprise network, an unsecure network such as a wireless open network, or the Internet. Network(s) 570 provide communication between the nodes described herein. By way of example, and not limitation, network(s) 570 may include wired media such as a wired network or direct-wired connection, and wireless media such as acoustic, RF, infrared and other wireless media.

Many other configurations of computing devices, applications, data sources, data distribution systems may be employed to implement personal information exchange using a plug-in module in a personal handheld device. Furthermore, the networked environments discussed in FIG. 5 are for illustration purposes only. Embodiments are not limited to the example applications, modules, or processes.

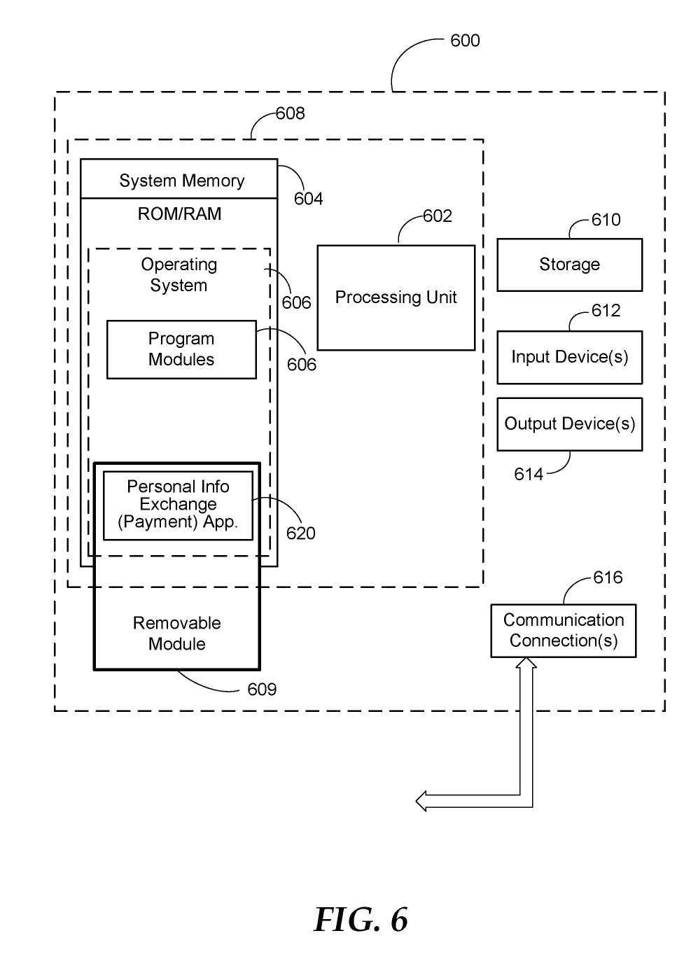

FIG. 6 and the associated discussion are intended to provide a brief, general description of a suitable computing environment in which embodiments may be implemented. With reference to FIG. 6, a block diagram of an example computing operating environment is illustrated, such as computing device 600. In a basic configuration, the computing device 600 may be any portable handheld device providing communication and other services to consumers in conjunction with a hosted service and typically include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of a networked personal computer, such as the WINDOWS® operating systems from MICROSOFT CORPORATION of Redmond, Wash. The system memory 604 may also include one or more software applications such as program modules 606. According to some embodiments, a personal information exchange application 620 associated with the module may be executed under the control of the operating system 606 but reside in removable module 609. According to other embodiments, the module may operate completely independently from the operating system of computing device 600 and only receive power from the device.

The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by storage 610. Computer storage media may include volatile and nonvolatile, removable and non-removable media implemented in any method or technology for storage of information, such as computer readable instructions, data structures, program modules, or other data. System memory 604, storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 612 such as keyboard, mouse, pen, voice input device, touch input device, etc. Output device(s) 614 such as a display, speakers, printer, etc. may also be included. These devices are well known in the art and need not be discussed at length here.

The computing device 600 may also contain communication connections 616 that allow the device to communicate with other computing devices, such as over a wireless network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

As discussed previously, removable module 609 communicates with other devices through its own communication circuitry. Removable module 609 may communicate employing near field communications, longer range wireless communications, wired communications such as described above, or optical communications.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

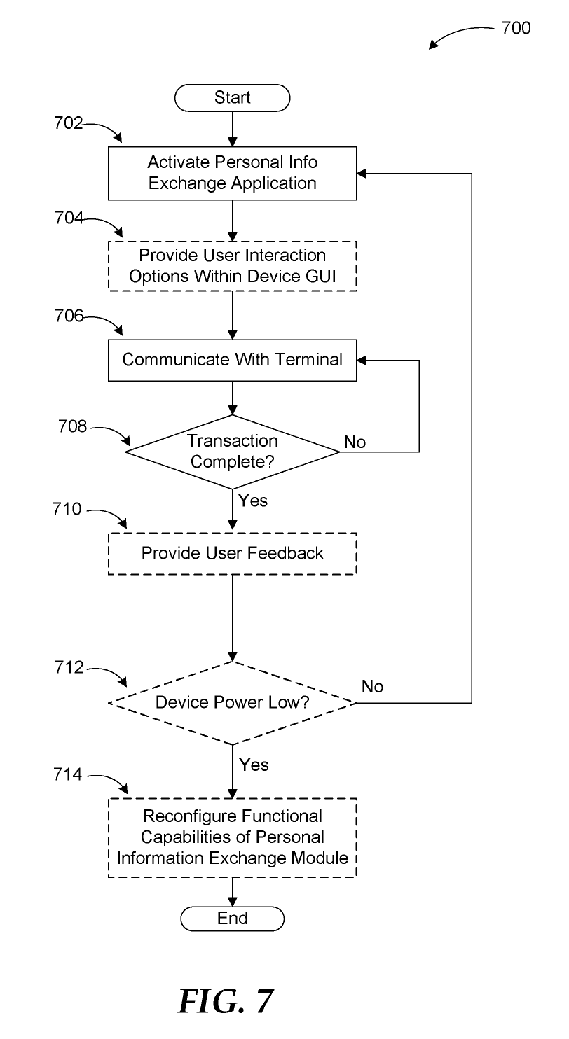

FIG. 7 illustrates a logic flow diagram for process 700 of facilitating a personal information exchange application within a personal handheld device environment. Process 700 may be implemented in a personal handheld device.

Process 700 begins with operation 702, where a personal information exchange application associated with a module according to embodiments is activated. The application may be activated by the user or by the module itself, for example upon sensing a nearby terminal for communication. Processing advances from operation 702 to optional operation 704.

At optional operation 704, user interaction options are provided through a GUI controlled by the operating system of the personal handheld device. According to some embodiments, the personal information exchange module may operate in an automated fashion without requiring user interaction. Processing moves from optional operation 704 to operation 706.

At operation 706, the module communicates with the terminal device to perform the intended transaction (e.g. make payment, access facilities, provide medical information, provide identity information, etc.). Processing moves from operation 706 to decision operation 708.

At decision operation 708, a determination is made whether the transaction is complete. If the transaction is not completed yet, processing returns to operation 706. If the transaction is complete, processing advances to optional operation 710.

At optional operation 710, the user is provided a feedback such as a GUI indication, an audio indication, or a graphical indication. Processing advances from optional operation 710 to optional decision operation 712.

At optional decision operation 712, a determination is made whether the personal handheld device power level is low. If there is still sufficient power available, processing returns to operation 702 for further transactions. If the power level is below a predefined threshold, processing moves to optional operation 714.

At optional operation 714, functional capabilities of the personal information exchange module are reconfigured. The reconfiguration may include limitation of some of the functionalities or a change of operational mode such as from an active module to a passive module such that the user can continue to perform the transactions even if the personal handheld device is turned off due to lack of power. After optional operation 714, processing moves to a calling process for further actions.

The operations included in process 700 are for illustration purposes. Facilitating a personal information exchange application within a personal handheld device environment may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing personal information exchange associated with a personal handheld device, the method comprising:
enabling a personal information exchange module to be plugged into the personal handheld device, wherein the module is configured to coordinate execution of an information exchange application such that sensitive code and sensitive data associated with the information exchange application is protected within the module;
activating the information exchange application; and
performing a personal information exchange transaction by communicating with a computing device through the module.

2. The method of claim 1, wherein the personal information exchange transaction includes at least one from a set of: a financial transaction, a facility access transaction, an exchange of medical information transaction, and a personal identity information exchange transaction.

3. The method of claim 1, wherein the information exchange application is executed completely within the module independent from an operating system of the personal handheld device.

4. The method of claim 1, wherein coordinating the execution of the information exchange application includes:
enabling the application to be executed within an operating system of the personal handheld device; and
enabling user interaction with the application through a Graphical User Interface (GUI) controlled by the operating system.

5. The method of claim 1, wherein the personal handheld device is one of: a cellular phone, a Personal Digital Assistant (PDA), a portable audio player, a portable video player, a remote control device, a portable medical monitoring device, and a portable communication device.

6. The method of claim 1, wherein the personal information exchange module is in a standardized form.

7. The method of claim 6, wherein the personal information exchange module is in a Subscriber Identity Module (SIM) form for connection to a standard SIM connector on a smart phone.

8. The method of claim 1, wherein the module is configured to communicate with the computing device employing one of: wireless communication, wired communication, optical communication, and near field communication.

9. The method of claim 1, wherein the module is configured to utilize a user authentication mechanism integrated into the personal handheld device before performing the transaction, and wherein the authentication mechanism includes at least one from a set of: Personal Identification Number (PIN) entry, fingerprint scanning, retina scanning, facial recognition, and voice recognition.

10. The method of claim 1, wherein at least one capability of the information exchange application is adjusted based on an available power level of the personal handheld device.

11. The method of claim 10, wherein the module is configured to switch from an active communication mode to a passive communication mode when the available power level drops below a predefined threshold such that the transaction can still be performed even if the personal handheld device is turned off due to lack of power.

12. The method of claim 1, wherein at least the information exchange application is activated in response to one of: a user indication through the personal handheld device, detection of the computing device, and a command received from the computing device.

13. A removable personal information exchange module to be plugged into a personal handheld device, the module comprising:
a memory;
a data store for storing sensitive data;
a processor coupled to the memory and the data store, wherein the processor is configured to execute program instructions for:
in response to one of a user indication and detection of a terminal, activate an information exchange application for exchanging personal data with the terminal for performing one of: a financial transaction, a facility access transaction, an exchange of medical information transaction, and a personal identity information exchange transaction;
storing received and updated data in the data store; and
upon completion of the transaction, provide a feedback to the user through the personal handheld device; and
a communication circuit for communicating with the terminal employing one of: wireless communication, wired communication, optical communication, and near field communication.

14. The module of claim 13, wherein the program instructions enable interaction of the information exchange application with the user through a GUI controlled by an operating system of the personal handheld device by using one of: a hard key, a soft key, a menu item, a display icon of the personal handheld device.

15. The module of claim 14, wherein the program instructions enable interaction of the information exchange application with the user through a GUI controlled by the module, and wherein the GUI interacts with at least one peripheral of the personal handheld device.

16. The module of claim 13, wherein at least one capability of the information exchange application is disabled in response to an available power level of the personal handheld device dropping below a predefined threshold.

17. The module of claim 13, wherein the processor is further configured to switch the communication circuit from an active communication mode to a passive communication mode in response to an available power level of the personal handheld device dropping below a predefined threshold.

18. A computer-readable storage medium with instructions stored thereon for enabling performance of financial transactions through a portable communication device, the instructions comprising:
activating a financial transaction application controlled by a removable module plugged into the portable communication device in response to a user indication through the portable communication device;
communicating with a terminal to provide personal data associated with the user for performing the financial transaction;
updating data stored in the removable module based on the performed transaction;
in response to detecting a drop of an available power level of the portable communication device, adjusting at least one capability of the removable module such that the transaction can be completed even if the portable communication device is turned off due to lack of power; and
providing a feedback to the user upon completion of the transaction.

19. The computer-readable storage medium of claim 18, wherein the user indication is one from a set of: pressing a hard key, pressing a soft key, selection of an icon on a touch-sensitive display, and pressing of a combination of keys, and wherein the terminal is a Point of Sale (POS) terminal.

20. The computer-readable storage medium of claim 18, wherein the removable module is configured to store sensitive data associated with at least one account of the user.
